(19) United States
(12) Patent Application Publication
(10) Pub. No.: US 2017/0271788 A1
(43) Pub. Date: Sep. 21, 2017

(54) GROUNDING DEVICE

(71) Applicant: RV GROUNDMATE, INC., Morrison, IL (US)

(72) Inventors: Steve T. Addington, Deer Grove, IL (US); Nickolas S. Popovich, Dixon, IL (US)

(21) Appl. No.: 15/443,908

(22) Filed: Feb. 27, 2017

Related U.S. Application Data
(60) Provisional application No. 62/300,643, filed on Feb. 26, 2016.

(51) Int. Cl. H01R 4/66

(52) U.S. Cl. CPC H01R 4/66; H01R 2201/26

(57) ABSTRACT

A portable grounding device for effective grounding of a motor vehicle is provided. The portable grounding device can be attached to a motor vehicle like a recreational vehicle to avoid the dangers associated with a hot-skin condition. The portable grounding device includes a housing, stake, and a wire. Additionally, one or more magnets can be used to secure the portable grounding device to a motor vehicle while not in use.

### CROSS-REFERENCE TO RELATED APPLICATIONS

The present application is a nonprovisional patent application, which claims priority to U.S. Provisional Patent Application Ser. No. 62/300,643, filed Feb. 26, 2016, and having the title “GROUNDING DEVICE,” which is herein incorporated in its entirety.

### TECHNICAL FIELD OF THE DISCLOSED EMBODIMENTS

The embodiments herein generally relate to a portable grounding device and, more particularly, to a portable grounding device for a motor vehicle.

### BACKGROUND OF THE DISCLOSED EMBODIMENTS

Nearly 9 million households in the United States own recreational vehicles, or RVs. A typical RV has interior living quarters sufficient for cooking, dining, and sleeping. Many RVs also include various electronically operated appliances such as a refrigerator, stove, and an air conditioner. Generally, the electricity to operate these appliances is provided by an outside power source provided by the park or facility, or a garage outlet, where the RV is parked. Often these power outlets have improper grounding or no grounding, or the RV itself may have faulty wiring. Therefore, a situation can arise in which the frame of a motor vehicle like an RV is no longer at the same voltage potential as the earth around it, or what is referred to as a hot-skin condition.

The hot-skin condition of a motor vehicle like an RV is not readily apparent because the rubber tires act to insulate the metal frame, or skin, of the RV. Therefore, an individual would have no visual indication of a hot-skin condition, or an electrically charged frame, until it is too late. By touching the skin, such as when opening the door of an RV, a person's body provides a path to the earth, thus completing the connection from the hot-skin to the earth. This situation results in current flowing through the individual causing the individual to be shocked or even electrocuted, possibly causing the individual's heart to go into fibrillation.

The risk of shock or electrocution is further exacerbated by circumstances where the ground underneath the individual is wet from a recent rain, the individual's hands or feet are wet, or the individual is not wearing shoes. The severity of the shock will vary depending on the voltage on the skin and how much moisture is on the individual and in the ground.

A voltmeter or non-contact AC voltage tester can be used to determine whether a hot-skin condition exists for a particular motor vehicle. However, changes in the power source can result in a hot-skin condition at any time. Thus, a motor vehicle should be checked for a hot-skin condition any time before entering the motor vehicle, which is not practical especially when children are frequently exiting and entering.

Therefore, a need exists for a grounding device that can be attached to a motor vehicle to eliminate a hot-skin condition. This device would avoid the risk from improper grounding or no grounding of electrical outlets without requiring repeated testing for a possible hot-skin condition. A need further remains for a portable grounding device that can be easily stored on the motor vehicle such that the device can be quickly removed and connected upon arriving at a campsite or other location, prior to connecting the motor vehicle to the electrical supply source.

### SUMMARY OF THE DISCLOSED EMBODIMENTS

In one embodiment, a portable grounding device is provided. The portable grounding device can be attached to a motor vehicle like an RV to ensure proper grounding and avoid a hot-skin condition. In another embodiment, the portable grounding device can be attached to the skin of an RV. The portable grounding device is self-contained, thus no additional equipment is necessary to provide an effective ground. Furthermore, the portable grounding device can be easily stored on the motor vehicle for easy access and attachment prior to connecting the motor vehicle to a power supply.

In one embodiment, the portable grounding device comprises a housing, wire, and stake. In one embodiment, the housing is a cuboid comprising an elongated slot in the front face of the housing. In another embodiment, the housing is secured to the stake via one or more couplings such that the stake is coaxially housed within the one or more couplings and the housing fits over and substantially covers the outside of the couplings. In one embodiment, the housing surrounds a portion of the stake and provides storage for the wire. In another embodiment, the housing is a rectangular cuboid. It should be understood by one of skill in the art that other shapes for the housing may be utilized. In a further embodiment, the stake is a copper clad steel stake.

In one embodiment, the housing comprises one or more magnets attached to the housing. In another embodiment, the one or more magnets are attached to the front face of the housing. The one or more magnets can be used to store the portable grounding device on the metal frame or other magnetic component of the motor vehicle when not in use.

In another embodiment, the wire of the portable grounding device is secured to the portion of the stake surrounded by the housing. The housing provides storage for the wire when not in use. In one embodiment, access to the wire is available through the elongated slot on the front face of the housing. In one embodiment, one end of the wire is secured to the stake, and the opposite free end of the wire includes a wire eyelet that can be secured to the motor vehicle. In another embodiment, the free end of the wire includes a wire clamp. In a further embodiment, the free end of the wire includes a three-prong plug that can be plugged into a receptacle. It should be understood by one of skill in the art that other electrical wire terminals may be connected to the free end of the wire in order to attach the wire to a motor vehicle.

In one embodiment, the end of the stake opposite the housing has a point for driving the stake into the ground. In another embodiment, the stake of the portable grounding device is secured in the ground at a location near a motor vehicle such that the free end of the wire may be attached to the motor vehicle.

Other embodiments are also disclosed.

### BRIEF DESCRIPTION OF DRAWINGS

The embodiments described herein and other features, advantages and disclosures contained herein, and the manner of attaining them, will become apparent and the present disclosure will be better understood by reference to the following description of various exemplary embodiments of the present disclosure taken in conjunction with the accompanying drawing, wherein:

FIG. 1 is a front perspective view of a portable grounding device in accordance with an embodiment.

FIG. 2 is a back perspective view of a portable grounding device in accordance with an embodiment.

FIG. 3 is a front perspective view of a disassembled portable grounding device in accordance with an embodiment.

FIG. 4 is a back perspective view of a portable grounding device secured to the rear of a motor vehicle in accordance with an embodiment.

FIG. 5 is a back perspective view of a portable grounding device secured to a recreational vehicle in accordance with an embodiment.

FIG. 6 is a back perspective view of a portable grounding device secured to the frame of a motor vehicle in accordance with an embodiment.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

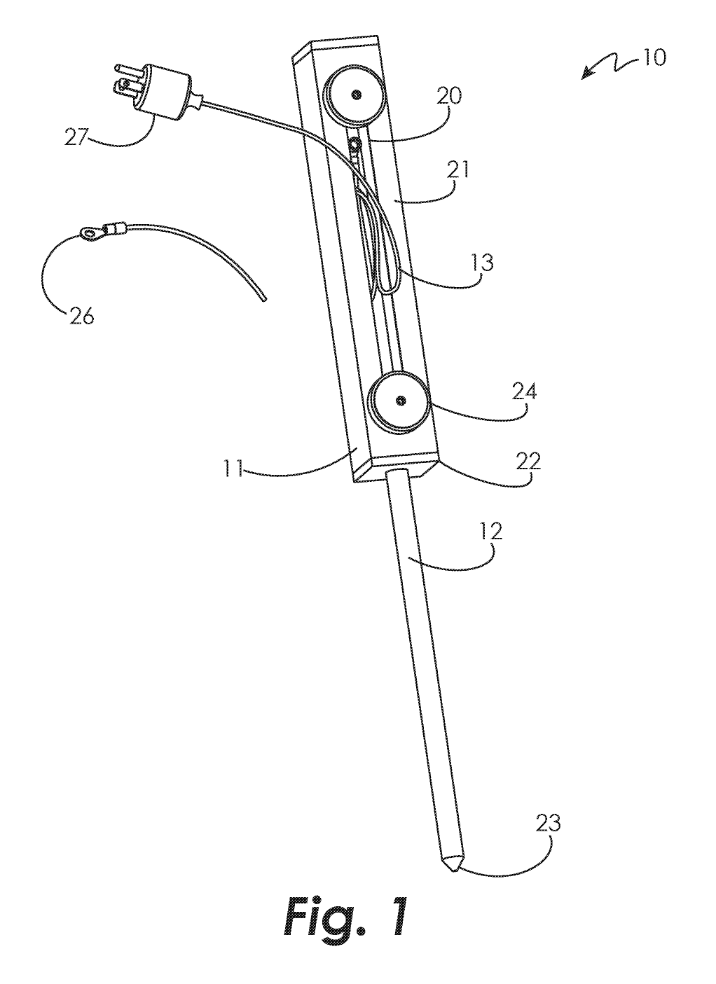

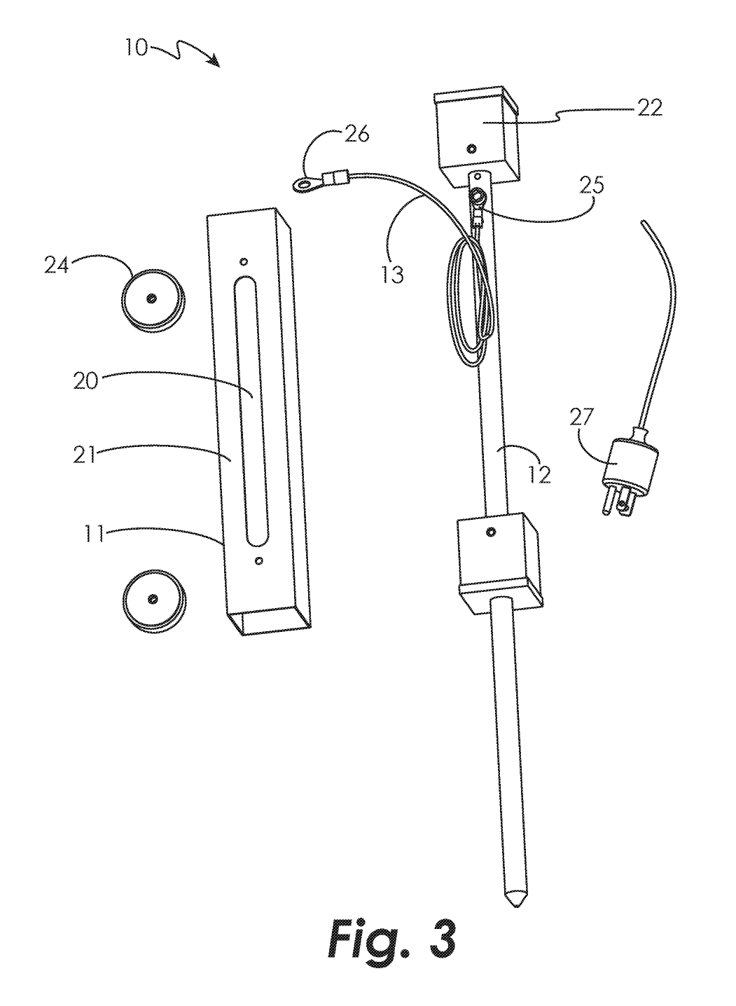

With reference to FIGS. 1-3, a portable grounding device 10 of an embodiment is shown. The portable grounding device 10 comprises a housing 11, a stake 12, and a wire 13. In the embodiment shown in FIGS. 1-3, the housing 11 is a rectangular cuboid comprising an elongated slot 20 in the rectangular front face 21 of the housing 11. It should be understood by one of skill in the art that various shapes for the housing 11 may be utilized. In the disclosed embodiments, the stake 12 is a copper clad steel stake, although any conductive material may be used.

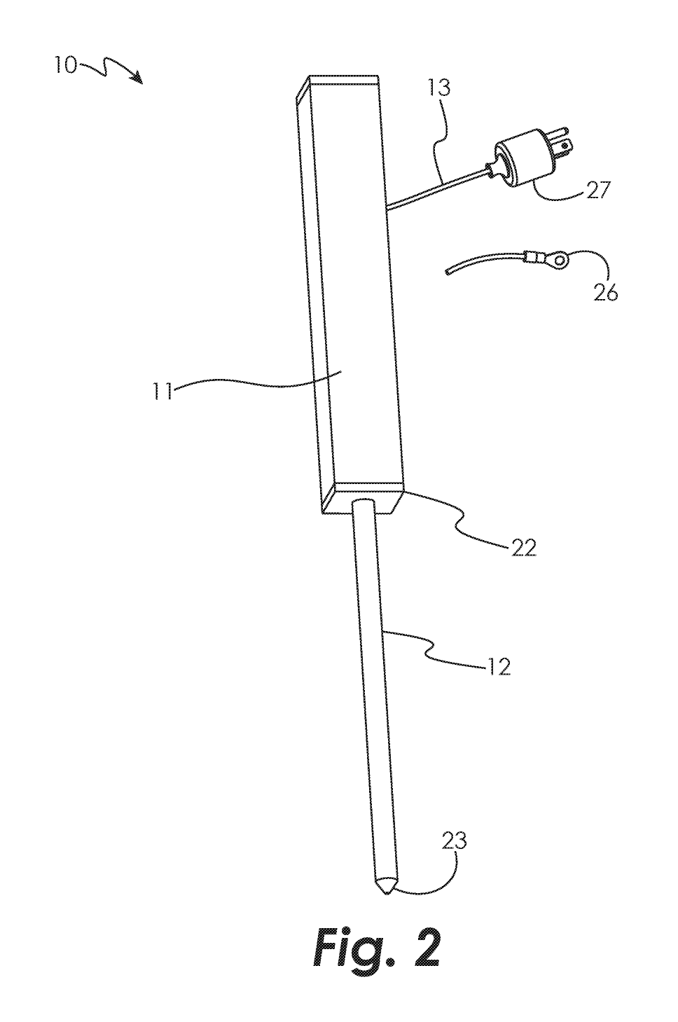

The housing 11 is secured to the stake 12 via one or more couplings 22 such that the stake 12 is coaxially positioned within the one or more couplings 22 and the housing 11 fits over and substantially covers the outside of the couplings 22. When the portable grounding device 10 is assembled as in FIGS. 1-2, the housing 11 surrounds a portion of the stake 12 and the one or more couplings 22. The end of the stake 12 opposite the housing comprises a point 23 such that the point 23 of the stake 12 may be secured in the ground.

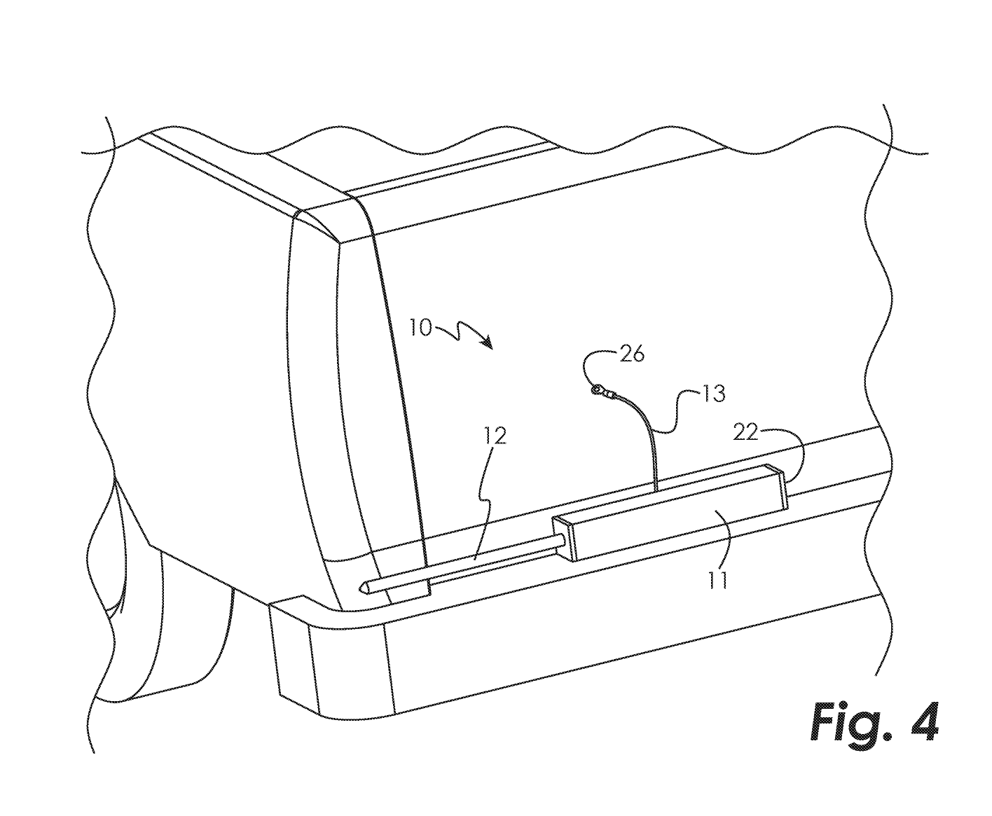

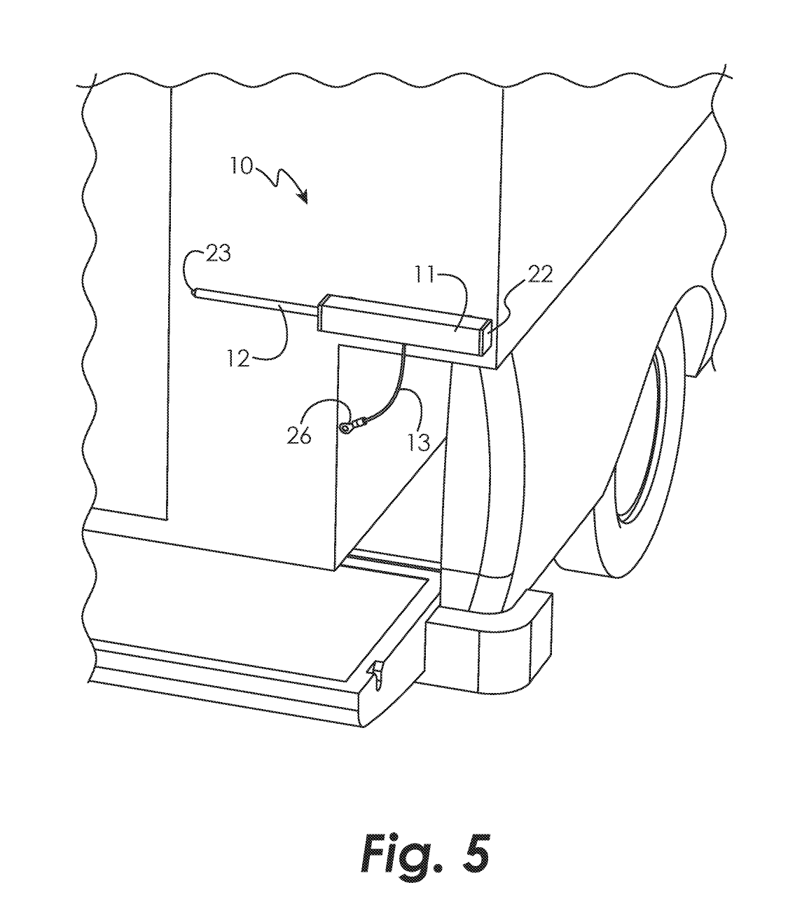

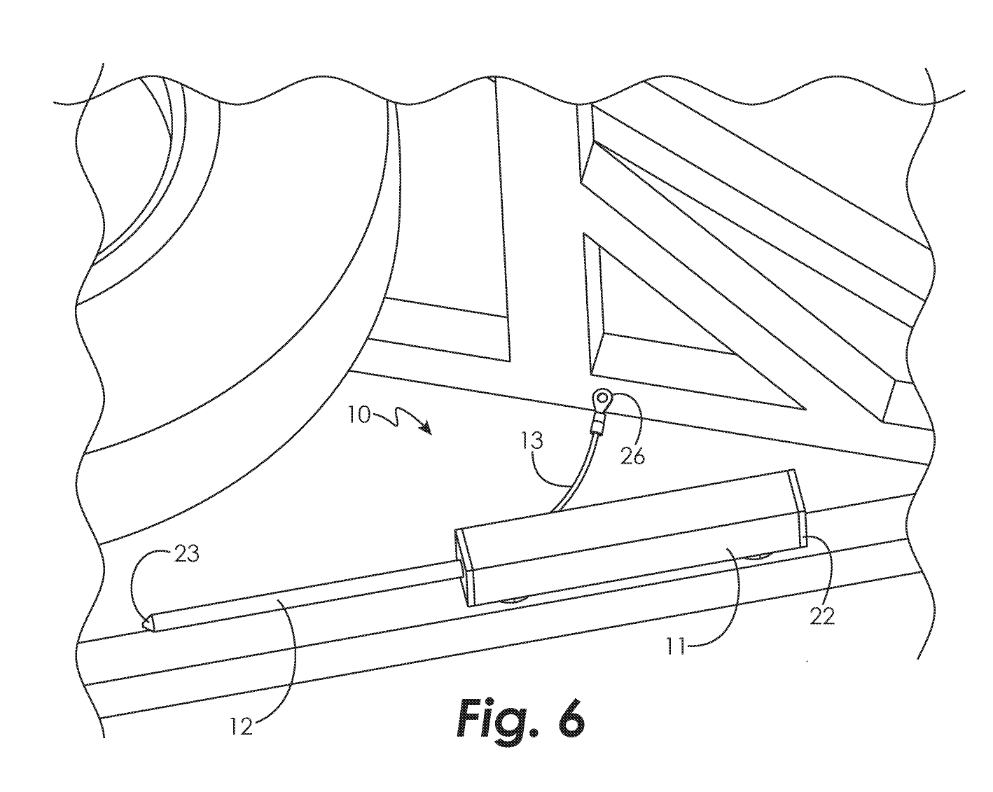

The housing 11 can also comprise one or more magnets 24 attached to the rectangular front face 21 of the housing 11. The one or more magnets 24 can be used to store the portable grounding device 10 on a ferrous component of a motor vehicle as shown in FIGS. 4-6 in a few non-limiting examples. The one or more magnets 24 allow for the portable grounding device 10 to be easily transported and stored with the motor vehicle.

The wire 13 of the portable grounding device 10 is secured to the stake 12 such that the wire 13 can be stored within the housing 11. The wire 13 can be secured to the stake 12 using a metal eyelet 25 in one embodiment. As shown in FIGS. 1-3, the free end of the wire 13 can include a metal eyelet 26 for attaching the wire to a conductive portion of the RV by means of a bolt. Alternatively, the free end of the wire 13 can include a three-prong plug 27 for attaching the wire to an electrical outlet of the electrical system of the RV. Alternatively, the free end of the wire 13 could also include a metal clamp (not shown) for attaching the wire to a conductive portion of the RV. It should be understood by one of skill in the art that other electrical wire terminals may be connected to the free end of the wire in order to attach the wire to a motor vehicle.

It will be appreciated from the present disclosure that the conductive coupling of the portable grounding device 10 to the conductive portions of the RV provides a known path to ground through the stake 12. Therefore, the embodiments described herein provide a portable grounding device for avoiding a hot-skin condition. The portable grounding device 10 avoids the risk from improper grounding or no grounding of electrical outlets without requiring repeated testing for a possible hot-skin condition. Furthermore, the portable grounding device can be easily stored on a motor vehicle like an RV such that the device can be quickly removed and easily connected upon arriving at a campsite or other location, prior to connecting the motor vehicle to the electrical supply source.

While the embodiments have been illustrated and described in detail in the drawings and foregoing description, the same is to be considered as illustrative and not restrictive in character, it being understood that only certain embodiments have been shown and described and that all changes and modifications that come within the spirit of the embodiments are desired to be protected.

1. A grounding device comprising:
an elongated stake made of an electrically conductive material and comprising a first stake end and a second stake end;
a wire comprising a first wire end operatively coupled to the stake, and further
comprising a second wire end; and
a housing;
wherein the stake is coaxially positioned within the housing such that the first stake end and the first wire end are received within the housing; and
wherein the second wire end extends from the housing.

2. The grounding device of claim 1 wherein the second stake end comprises a substantially pointed region for penetrating and inserting the grounding device into the ground.

3. The grounding device of claim 1 wherein the stake is made from copper clad steel.

4. The grounding device of claim 1 wherein the first wire end is connected to the stake at a location near the first stake end such that the wire can be stored within the housing.

5. The grounding device of claim 4 wherein the first wire end is connected to the stake by a metal eyelet.

6. The grounding device of claim 1 wherein the housing comprises an elongate slot for accessing the wire.

7. The grounding device of claim 1 wherein the second wire end comprises an electrical wire terminal for connecting the grounding device to a vehicle to be grounded.

8. The grounding device of claim 7 wherein the electrical wire terminal is selected from the group consisting of a metal eyelet, a three-prong plug, or a metal clamp.

9. The grounding device of claim 1, further comprising at least one magnet operatively coupled to the housing for attaching the grounding device to a ferrous object for transport or storage.

10. The grounding device of claim 9 wherein the at least one magnet comprises a plurality of magnets.

11. A method for grounding a vehicle, comprising the steps of:
providing a grounding device, the grounding device comprising:
an elongate stake made of an electrically conductive material and comprising a first stake end and a second stake end; and
a wire comprising a first wire end operatively coupled to the stake, and further comprising a second wire end;
applying force to the grounding device until the second stake end penetrates the ground surface to secure the grounding device in the ground;
conductively connecting the second wire end to the vehicle.

12. The method of claim 11, wherein the step of conductively connecting the second wire end to the vehicle comprises securing a metal eyelet on the second wire end to a ferrous portion of the vehicle.

13. The method of claim 11, wherein the step of conductively connecting the second wire end to the vehicle comprises plugging a three-prong plug on the second wire end into an electrical outlet of an electrical system of the vehicle.

14. The method of claim 11, wherein the step of conductively connecting the second wire end to the vehicle comprises securing a clamp on the second wire end to a ferrous portion of the vehicle.
